(19) United States
(12) Patent Application Publication
(10) Pub. No.: US 2008/0150783 A1
(43) Pub. Date: Jun. 26, 2008

(54) Electronic device with hotkey remote controller

(75) Inventor: Chun-Jung Huang, Taipei (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Inventec Corporation, Taipei City (TW)

(21) Appl. No.: 11/644,662

(22) Filed: Dec. 22, 2006

(51) Int. Cl. G08C 19/00

(52) U.S. Cl. 341/176

(57) ABSTRACT

An electronic device with a hotkey remote controller is provided, wherein the remote controller can be used to remotely input a signal to the electronic device, and the remote controller also can be connected to the electronic device for direct input of the signal. A pair of signal connection ports and a pair of power connection ports are disposed on the hotkey remote controller and the host of the electronic device respectively. When the signal connection ports and the power connection ports are coupled, a signal switch element and a power switch element are triggered immediately, the signal transmitted by the hotkey remote controller is transferred to the host via the signal connection ports, and the electrical energy demanded by the remote controller is supplied by the electronic device via the power connection ports, such that the effect of sharing a group of keys and power management is achieved.

### BACKGROUND OF THE INVENTION

1. Field of Invention

The present invention relates to an electronic device, and more particularly, to an electronic device with a hotkey remote controller.

2. Related Art

Recently, with the increasing development and innovation of science and technology, an information explosion era of transmitting and receiving a large quantity of information has appeared. Electronic products have gradually developed from the early personal computer (PC) towards the portable computer of notebook with multi-media functionality, which is light, thin, short, and small. Furthermore, the mobile phone, personal digital assistant (PDA), MP3 player, and other portable multi-media products have been developed. To facilitate a user's control of the audio/video light electronic products, a remote controller has been developed for the user to control them remotely.

The conventional remote controller and associated electronic products on the market are separated units, but the size of the conventional remote controller is small, and no suitable accommodation methods are provided, such that the remote controller is always lost. To solve this problem, in the conventional technique of patent No. 555,032 “remote controller for notebook computer” issued in Taiwan Patent Gazette on Sep. 21, 2003, adding an accommodation device on the portable electronic device for storing the remote controller is mentioned. However, in this way, an extra manufacturing procedure and cost are added, and also the volume of the portable electronic device is increased, such that the light and convenient electronic device becomes ponderous, bulky, and inconvenient for being carried. A patent No. 555032 “remote controller for notebook computer” issued in Taiwan Patent Gazette on Sep. 21, 2003, a patent No. M242,791 “wireless remote controller accommodated in PCMCIA socket of notebook computer” issued in Taiwan Patent Gazette on Sep. 1, 2004, and a patent No. M273,138 “thin remote controller” issued in Taiwan Patent Gazette on Aug. 11, 2005 have disclosed that, the notebook computer currently sold on the market has changed to transmit data via USB or infrared rays, such that the PCMCIA socket is set aside, and then the remote controller is accommodated in the PCMCIA socket; thereby the problem of installing an extra accommodation device is solved.

As the remote controller and the electronic device are two separate units, the signal can only be transferred between them via wireless transmissions, and therefore, in the conventional process for manufacturing the electronic device with a remote controller, two groups of control keys being the same and provided with the same functionality must be allocated on the remote controller and the portable electronic device respectively, resulting in manufacturing costs of key modules with repeated functions. Furthermore, as for the user, since the remote controller requires batteries to operate, the expense of buying batteries is not a small cost.

### SUMMARY OF THE INVENTION

In view of the above problems, the present invention provides an electronic device with a hotkey remote controller, thereby improving the limits or disadvantages of the prior art.

An object of the present invention is to set at least one accommodation portion on the surface of the host of the electronic device, for accommodating a hotkey remote controller associated with the electronic device, so as to improve the problem that the remote controller is missing due to difficulties in being reserved, and to eliminate an extra accommodation device.

Another object of the present invention is enabling the electronic device and the remote controller to share a group of hotkeys. The electronic device is coupled with the remote controller by signal connection ports, and via the signal connection ports, the signal data input from the remote controller is transmitted to the host of the electronic device. In the manufacturing process, the time and cost of manufacturing a group of hotkey modules can be saved; the production capacity can be enhanced; and the manufacturing cost can also be reduced.

Further object of the present invention is enabling the remote controller and the electronic device to share one power. The electronic device is coupled with the remote controller by power connection ports, and through the power connection ports, the electrical energy demanded by the remote controller is supplied by the electronic device. In addition, the battery of the remote controller can be a secondary battery, when the power connection ports of the remote controller is coupled to that of the electronic device, the secondary battery can be charged, and can be used repeatedly, so as to save the cost of buying batteries.

It is an advantage of the present invention that the hotkey remote controller can be accommodated to the host of the electronic device, so that the accommodating problem of the hotkey remote controller is solved, and the electronic device and the hotkey remote controller share a group of hotkeys and one power, not only enhancing the production capacity but also reducing the manufacturing cost.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus which is not limitative of the present invention, and wherein:

FIG. 1 is a block diagram of the present invention; and

FIG. 2 is a schematic stereogram of the present invention.

### DETAILED DESCRIPTION OF THE INVENTION

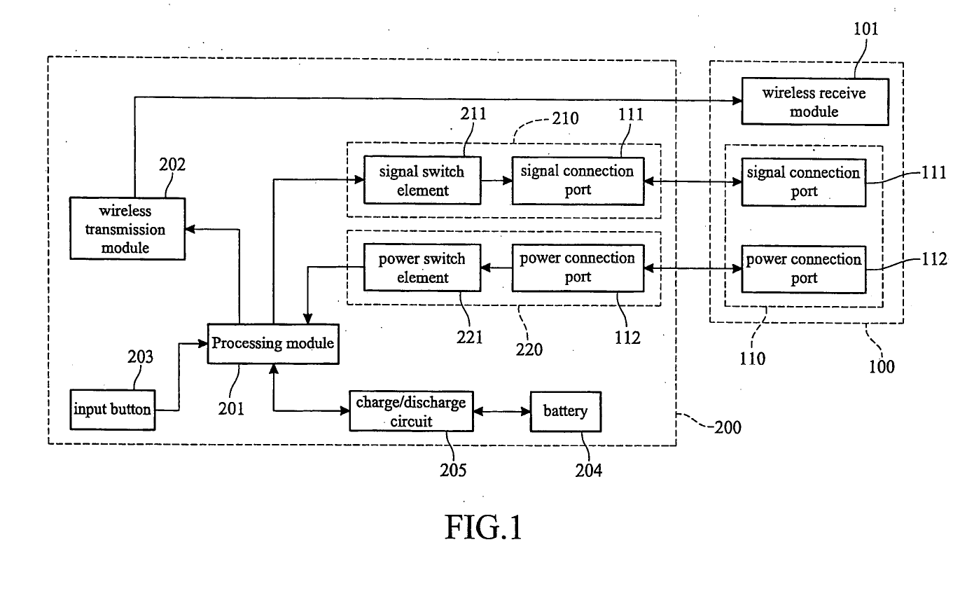

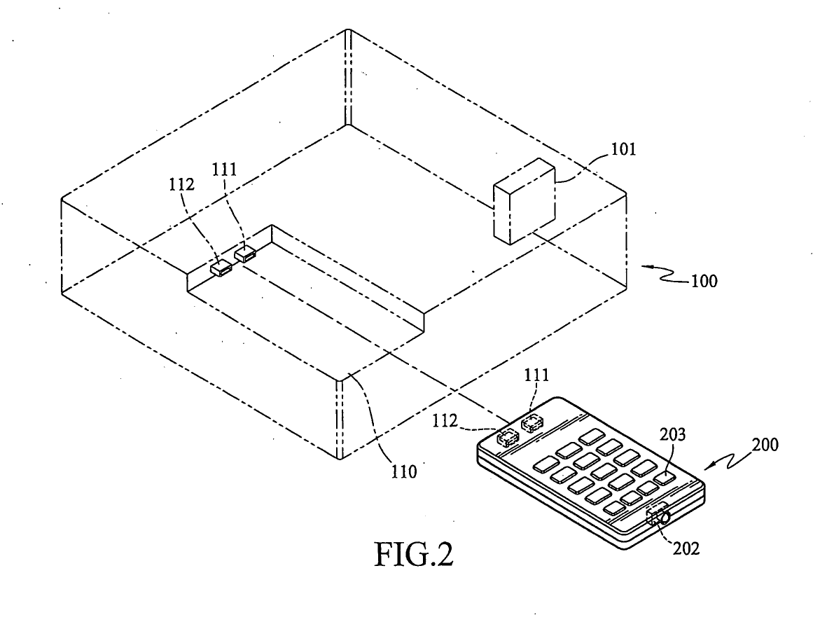

Please refer to FIG. 1 and FIG. 2. FIG. 1 is a block diagram of an electronic device with a hotkey remote controller according to the present invention. FIG. 2 is a schematic stereogram of an electronic device with a hotkey remote controller according to the present invention. As shown in FIGS. 1 and 2, the electronic device of the present invention includes a host 100 having a wireless receive module 101 and at least one accommodation portion 110. The accommodation portion 110 is provided with a signal connection port 111 and a power connection port 112 therein. A hotkey remote controller 200 associated with the host 100 includes a processing module 201 for receiving and transmitting signals, a signal module 210 having a signal connection port 111 and a signal switch element 211, a power module 220 having a power connection port 112 and a power switch element 221, a wireless transmission module 202 electrically connected with the processing module 201, a group of input keys 203 disposed on the surface of the hotkey remote controller 200 and electrically connected to the processing module 201, and a battery 204 electrically connected to the processing module 201. Furthermore, the signal connection port 111 and the signal switch element 211 are electrically connected with processing module 201, and the power connection port 112 and the power switch element 221 are electrically connected with the processing module 201.

When the signal connection port 111 and the power connection port 112 of the hotkey remote controller 200 are coupled with that of the accommodation portion 110 respectively, the signal transmitted by the input key 203 is transferred to the host 100 via the signal connection ports 111 for being read, and the electrical energy demanded by the hotkey remote controller 200 is supplied by the electronic device through the power connection ports 112. When the signal connection ports 111 and the power connection port 112 of the hotkey remote controller 200 are separated from that of the accommodation portion 110, the signal transmitted by the input key 203 is transferred to the wireless receive module 101 of the host 110 via the wireless transmission module 202, and the electrical energy of the hotkey remote controller 200 is supplied by the battery 204 instead.

As shown in FIGS. 1 and 2, the signal is transmitted between the wireless transmission module 202 and the wireless receive module 101 through infrared rays. The input key 203 of the hotkey remote controller 200 includes a group of multi-media playing control keys, a browser start key, an E-mail start key, and a fast on/off key. Furthermore, the battery 204 for the hotkey remote controller 200 can be a secondary battery that can be repeatedly used. The hotkey remote controller 200 is provided with a charge/discharge circuit 205 electrically connected with the processing module 201 and the battery 204. When the power connection ports 112 of the hotkey remote controller 200 is coupled to that of the accommodation portion 110, the electronic device supplies electrical energy for charging the battery 204.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic device with a hotkey remote controller, comprising:
a host having at least one accommodation portion and a wireless receive module, the accommodation portion having a signal connection port and a power connection port; and
a remote controller, comprising:
a processing module for receiving and transmitting signal data;
a signal module having a signal connection port and a signal switch element, the signal connection port and the signal switch element being electrically connected with the processing module;
a power module having a power connection port and a power switch element, the power connection port and the power switch element being electrically connected with the processing module;
a wireless transmission module electrically connected with the processing module;
a group of input keys disposed on the surface of said remote controller and electrically connected with the processing module; and
a battery electrically connected with the processing module;
wherein when the signal connection ports and the power connection ports are coupled, the signal switch element and the power switch element are triggered immediately, the signal transmitted by the input key is transferred to said host via the signal connection ports, and the electrical energy is supplied by said electronic device through the power connection ports; and wherein when the signal connection ports and the power connection ports are separated, the signal transmitted by the input key is transferred to the wireless receive module via the wireless transmission module, and the electrical energy is supplied by the battery.

2. The electronic device with a hotkey remote controller according to claim 1, wherein the signals are transmitted between the wireless transmission module and the wireless receive module via infrared rays.

3. The electronic device with a hotkey remote controller according to claim 1, wherein the input key comprises:
a group of multi-media play keys;
a browser start key;
an E-mail start key; and
a fast on/off key.

4. The electronic device with a hotkey remote controller according to claim 1, wherein the battery is a secondary battery.

5. The electronic device with a hotkey remote controller according to claim 4, wherein the remote controller has a charge/discharge circuit electrically connected with the secondary battery, and when the power connection ports are coupled, the electronic device supplies electrical energy for charging the secondary battery.
